(19) United States
(12) Patent Application Publication
(10) Pub. No.: US 2017/0032172 A1
(43) Pub. Date: Feb. 2, 2017

(54) ELECTRONIC DEVICE AND METHOD FOR SPLICING IMAGES OF ELECTRONIC DEVICE

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(21) Appl. No.: 14/812,741

(22) Filed: Jul. 29, 2015

(51) Int. Cl. G06K 9/00; G06T 7/00; G06T 1/00

(52) U.S. Cl. CPC G06K 9/0061; G06T 1/0007; G06T 7/0042; G06T 2207/10004; G06T 2207/30201

(57) ABSTRACT

In a method for splicing images of an electronic device, images of users are acquired from a storage system of the electronic device. The method identifies eye states of the users in the images. An image combination with eyes of all the users opened is determined from the images based on the eyes states. A primary image is determined from the image combination. The method replaces closed eyes of each primary image with opened eyes of one or more other images of the image combination. The primary image is displayed on a display screen of the electronic device.

### FIELD

The subject matter herein generally relates to image splicing technology, and particularly to an electronic device and a method for splicing images of the electronic device.

### BACKGROUND

When a group photo of plurality of users is taken, each member of the group should open his eyes for obtaining a satisfactory group photo. However, in order to take a good photo, the members of the group may pose over and over again to ensure the eyes of all group members are opened, and several photos are taken until the satisfactory group photo is obtained. Time and energy of the group members in these circumstances is wasted.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including an image splicing system.

FIG. 2 illustrates a flowchart of one embodiment of a method for splicing images of the electronic device in FIG. 1.

FIG. 3 illustrates a plurality of images captured by a camera unit of the electronic device in FIG. 1.

FIG. 4 is a diagrammatic view of one embodiment for identifying eye states of users from the plurality of images in FIG. 3.

FIG. 5 is a diagrammatic view of one embodiment for recording eye states of users as binary digits, for the plurality of images in FIG. 3.

FIG. 6 is image combinations of images, a logical OR operation between binary digits of each user of the images having been done.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

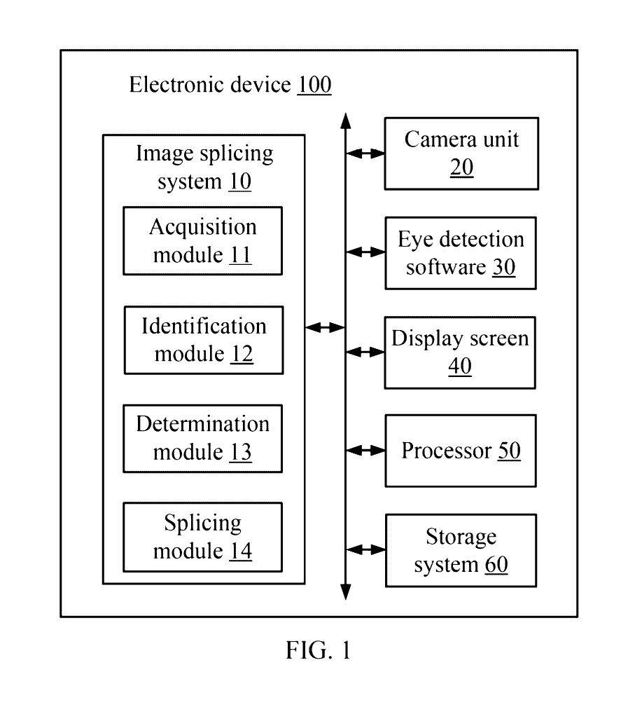

FIG. 1 illustrates a block diagram of one embodiment of an electronic device. Depending on the embodiment, an electronic device 100 includes an image splicing system 10. In one embodiment, the electronic device 100 can be a tablet computer, a notebook computer, a personal digital assistant, a mobile phone, a digital camera, or any other electronic device with a camera unit 20 having continuous shooting function. The electronic device 100 further includes, but is not limited to, an eye detection software 30, a display screen 40, at least one processor 50, and a storage system 60.

The camera unit 20 can be a camera with continuous shooting function for capturing a plurality of images of users, also known as automatic image capturing. The frames per second (fps) of the camera unit 20 is determined according to the capabilities of the electronic device 100, for example, 10 fps defines that the camera unit 20 can capture ten images per second.

The eye detection software 30 can identify facial areas of the users from the captured images using a facial recognition technology, and identify eye areas of the users from the facial areas of the captured images. The facial areas are surface areas including faces of the users. The eye areas are surface areas including eyes of the users. The eye detection software 30 can further detect the eyeballs in each eye area, and determine eye states of each user in the eye areas according to the visibility of eyeballs of each eye area. The eye states of each user include an opened state indicating eyes of the user are opened, with visible eyeballs, and a closed state indicating eyes of the user are closed. When the number of visible eyeballs is equal to two in an eye area, the eye detection software 30 determines that an eye state of a user in the eye area is in the opened state. When the number of visible eyeballs is less than two in the eye area, for example, equal to one or zero, the eye detection software 30 determines that the eye state of the user in the eye area is in the closed state.

The display screen 40 displays the plurality of images captured by the camera unit 20.

The at least one processor 50 can be a central processing unit (CPU), a microprocessor, or other data processor chip that performs functions of the electronic device 100.

In at least one embodiment, the storage system 60 can include various types of non-transitory computer-readable storage media. For example, the storage system 60 can be an internal storage system, such as a flash memory, a random access memory (RAM) for temporary storage of information, and/or a read-only memory (ROM) for permanent storage of information. The storage system 60 can also be an external storage system, such as a hard disk, a storage card, or a data storage medium. The storage system 60 can store the plurality of images captured by the camera unit 20.

The image splicing system 10 can determine eye states of the users in the plurality of images, and splice between images, or parts of images, according to the eye states of the users. In at least one embodiment, the image splicing system 10 can include an acquisition module 11, an identification module 12, a determination module 13, and a splicing module 14. The function modules 11-14 can include computerized code in the form of one or more programs, which are stored in the storage system 60. The at least one processor 50 executes the computerized code to provide functions of the function modules 11-14, as described below.

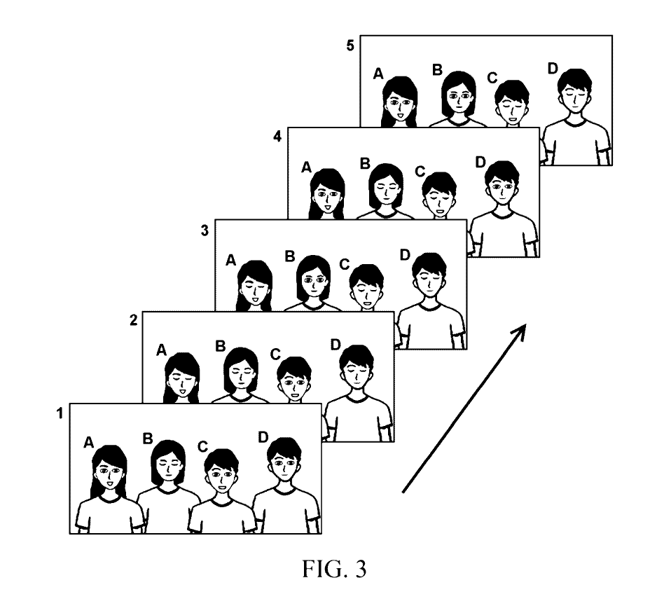

The acquisition module 11 is configured to acquire a plurality of images of users from the storage system 60. In one embodiment, when the camera unit 20 captures a plurality of images of users using continuous shooting function of the camera unit 20, the plurality of images of the users can be stored into the storage system 60. The continuous shooting function can determine the amount of images that the camera unit 20 can capture per second, for example, ten images per second. As an example shown in FIG. 3, five images of four unchanging users are captured by the camera unit 20 and stored to the storage system 60.

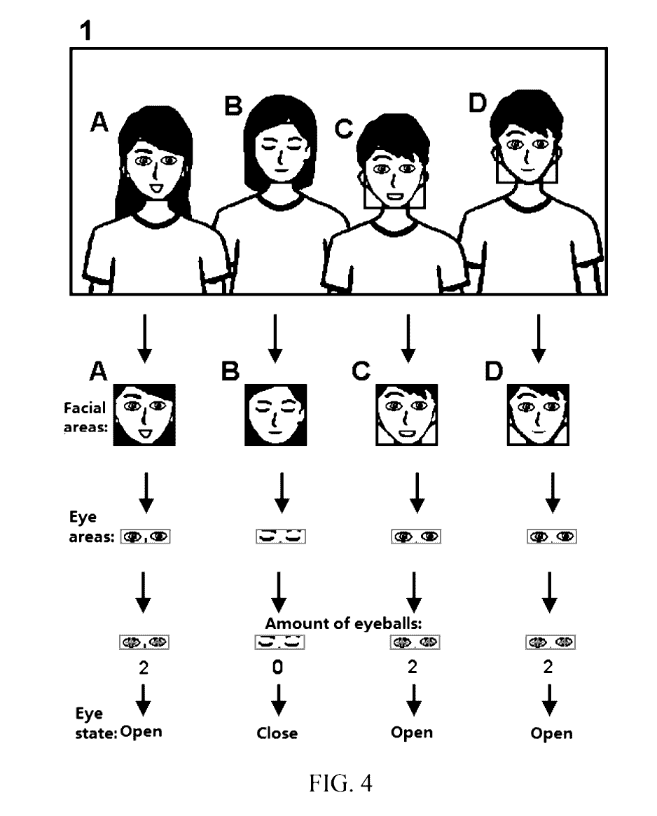

The identification module 12 is configured to identify eye states of the users in the plurality of images using the eye detection software 30. In the embodiment, the identification module 12 identifies facial areas of the users from the plurality of images using a facial recognition technology of the eye detection software 30. As an example shown in FIG. 4, facial areas of four users in the first image are identified. The identification module 12 further identifies eye areas of the users from the facial areas of the plurality of images. As an example shown in FIG. 4, four eye areas of the four users in the first image are identified from the facial areas of the first image. The identification module 12 detects the number of visible eyeballs in each eye area of the users in the plurality of images, and determines eye states of each user in the eye areas according to such number. When the number of visible eyeballs is equal to two in an eye area, the identification module 12 determines that an eye state is in an opened state indicating eyes opened. When the number of visible eyeballs is less than two in the eye area, for example, equal to one or zero, the identification module 12 determines that the eye state is in a closed state, indicating eyes closed. Eyes which are absent because of disease or accident are not considered by the identification module 12 when the eye state of the user is determined. As an example shown in FIG. 4, the number of visible eyeballs of the four eye areas of the four users in the first image is detected, and eye states of each of the four users in the first image are determined.

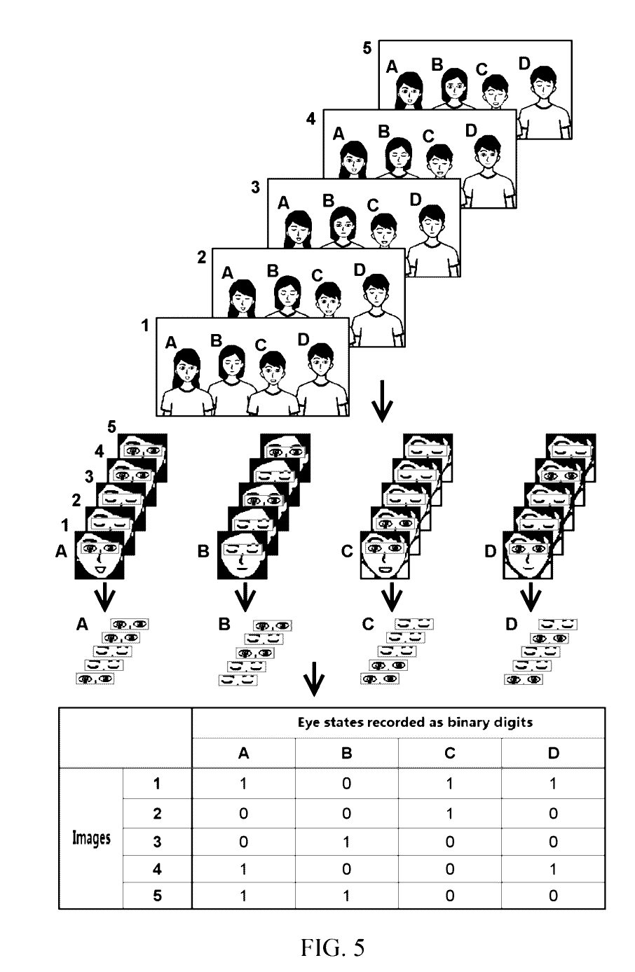

In at least one embodiment, the identification module 12 further records the eye states of the users in the plurality of images as binary digits, and stores the recorded binary digits to the storage system 60. In the illustrated embodiment, an opened eye state of a user is predetermined to be recorded as a binary digit “1”, and a closed eye state of the user is predetermined to be recorded as a binary digit “0.” As an example shown in FIG. 5, the eye states of the four unchanging users in the five images are recorded as binary digits and stored to the storage system 60. In other embodiments, the reverse can apply, namely that the opened eye state of the user can be recorded as a binary digit “0”, and the closed eye state of the user can be recorded as a binary digit “1.”

The determination module 13 is configured to determine whether an image with eyes of all the users opened exists, based on the eye states of the users. In the embodiment, the determination module 13 determines whether eye states of all the users of an image are all recorded as a single predetermined binary digit. For example, the single predetermined binary digit is equal to the binary digit of “1”. If the eye states of all the users of the image are all recorded as the single predetermined binary digit, the determination module 13 determines that the image with eyes of all the users opened exists. If an image with eye states of all the users all recorded as the predetermined binary digit does not exist, the determination module 13 determines that the image with eyes of all the users opened does not exist.

The splicing module 14 is configured to display the image with eyes of all the users opened on the display screen 40 when the image with eyes of all the users opened exists.

When the image with eyes of all the users opened does not exist, the splicing module 14 is further configured to determine an image combination which produces a resulting image in which eyes of all the users are opened, from the plurality of images based on the eye states. In the embodiment, the image combination can include two or more images obtained from the plurality of images.

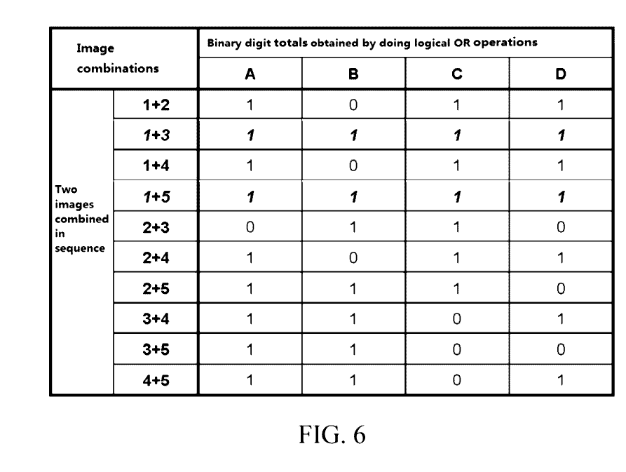

In the illustrated embodiment, the splicing module 14 acquires image combinations by combining any two of the plurality of images, and calculates binary digit totals each user of the acquired image combinations by doing logical OR operations thereon. As an example shown in FIG. 6, a logical OR operation is done between the recorded binary digits of each user of the acquired image combinations. The splicing module 14 further determines whether an acquired image combination with binary digital totals which can equal to a predetermined numeral exists. For example, the predetermined numeral is the binary digital of “1”. When the acquired image combination with binary digital totals which are all equal to the predetermined numeral does not exist, the splicing module 14 further combines any three of the plurality of images to acquire image combinations and calculates binary digit totals of each user of the acquired image combinations, and then combines any four of the plurality of images, and so on, until the acquired image combination with binary digital totals which are all equal to the predetermined numeral exists. When the acquired image combination with binary digital totals equal to the predetermined numeral exists, the splicing module 14 determines the acquired image combination with binary digital totals equal to the predetermined numeral as the determined image combination. As an example shown in FIG. 6, an image combination which includes the first image and the third image are determined as the determined image combination by the splicing module 14.

The splicing module 14 is further configured to determine a primary image from the image combination. In the embodiment, the splicing module 14 calculates the number of users with eyes opened in each image of the image combination, and determines an image with a largest number of users who have opened eyes as the primary image of the image combination. As an example shown in FIG. 5, the first image has three users who have opened eyes and the third image has one user who have opened eyes, the splicing module 14 determines the first image as the primary image of the image combination including the first image and the third image.

The splicing module 14 is further configured to replace closed eyes of the primary image with opened eyes of one or more other images of the image combination. In the embodiment, the splicing module 14 can obtain eye areas of the one or more other images of the image combination with eyes opened, and replace eye areas of the primary image with eyes closed with the obtained eye areas. In other embodiment, the splicing module 14 can obtain facial areas of the one or more other images of the image combination with eyes opened, and substitute those facial areas in the primary image where eyes are closed with the obtained facial areas. In other embodiment, the splicing module 14 can also obtain body areas of the one or more other images of the image combination with eyes opened, and substitute body areas of the primary image where eyes are closed with the obtained body areas. The body areas are surface areas of the bodies of users in the plurality of images.

The splicing module 14 is further configured to display the primary image on the display screen 40. In the embodiment, more than one image combination may be determined for producing a resulting image showing eyes of all the users opened, and more than one replaced primary image is displayed on the display screen 40. The splicing module 14 can obtain a preferred image selected from the more than one replaced primary image by an operator, and store the preferred image to the storage system 60.

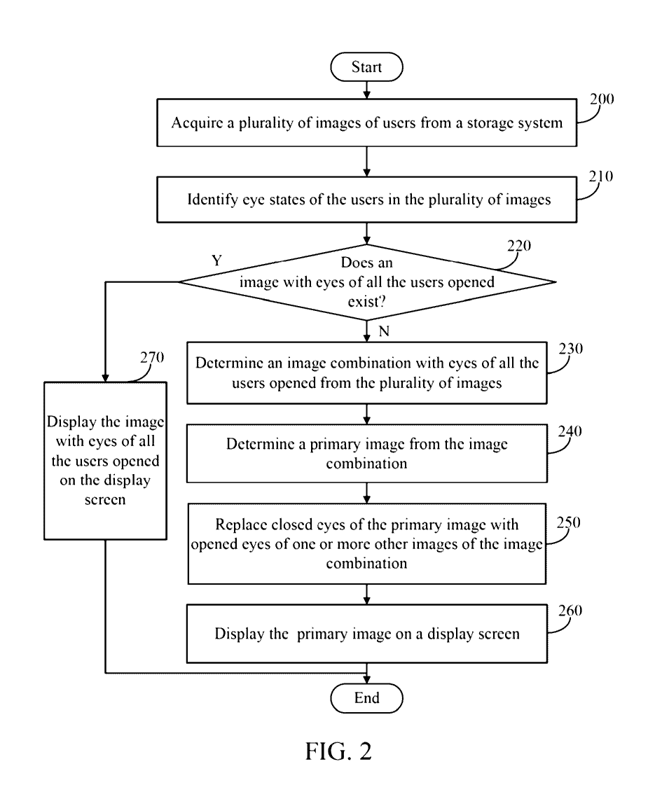

Referring to FIG. 2, a flowchart is presented in accordance with an example embodiment. The example method is provided by way of example, as there are a variety of ways to carry out the method. The method described below can be carried out using the configurations illustrated in FIG. 1, for example, and various elements of the figure are referenced in explaining example method. Each block shown in FIG. 2 represents one or more processes, methods, or subroutines, carried out in the exemplary method. Furthermore, the illustrated order of blocks is by example only and the order of the blocks can be changed. Additional blocks may be added or fewer blocks may be utilized, without departing from this disclosure. The exemplary method can begin at block 200. Depending on the embodiment, additional blocks can be added, others removed, and the ordering of the blocks can be changed.

At block 200, an acquisition module acquires a plurality of images of users from a storage system of an electronic device. In one embodiment, when a camera unit of the electronic device captures a plurality of images of the users using continuous shooting function of the camera unit, the plurality of images of the users can be stored into the storage system. The continuous shooting function can determine the amount of images that the camera unit can capture per second, for example, ten images per second.

At block 210, an identification module identifies eye states of the users in the plurality of images using an eye detection software of the electronic device. In the embodiment, the identification module identifies facial areas of the users from the plurality of images using a facial recognition technology of the eye detection software. The identification module further identifies eye areas of the users from the facial areas of the plurality of images. The identification module detects the number of visible eyeballs in each eye area of the users in the plurality of images, and determines eye states of each user in the eye areas according to such number. When the number of visible eyeballs is equal to two in an eye area, the identification module determines that an eye state is in an opened state indicating eyes opened. When the number of visible eyeballs is less than two in the eye area, for example, equal to one or zero, the identification module determines that the eye state is in a closed state indicating eyes closed.

In at least one embodiment, the identification module further records the eye states of the users in the plurality of images as binary digits, and stores the recorded binary digits to the storage system. In the embodiment, an opened eye state of a user is predetermined to be recorded as a binary digit “1”, and a closed eye state of the user is predetermined to be recorded as a binary digit “0.” In other embodiment, the reverse can apply, namely that the opened eye state of the user can be recorded as a binary digit “0”, and the closed eye state of the user can be recorded as a binary digit “1.”

At block 220, a determination module determines whether an image with eyes of all the users opened exists, based on the eye states of the users. If the image with eyes of all the users opened exist, block 230 is implemented. If the image with eyes of all the users opened does not exist, block 270 is implemented. In the embodiment, the determination module determines whether eye states of all the users of an image are all recorded as a single predetermined binary digit. For example, the single predetermined binary digit is equal to the binary digit of “1”. If the eye states of all the users of the image are all recorded as the single predetermined binary digit, the determination module determines that the image with eyes of all the users opened exists. If an image with eye states of all the users all recorded as the predetermined binary digit does not exist, the determination module determines that the image with eyes of all the users opened does not exist.

At block 230, a splicing module determines an image combination which produces a resulting image in which eyes of all the users are opened, from the plurality of images based on the eye states. In the embodiment, the image combination can include two or more images obtained from the plurality of images.

In the illustrated embodiment, the splicing module acquires image combinations by combining any two of the plurality of images, and calculates binary digit totals of each user of the acquired image combinations by doing logical OR operations thereon. The splicing module further determines whether an acquired image combination with binary digital totals which can all equal to a predetermined numeral exists. For example, the predetermined numeral is the binary digital of “1”. When the acquired image combination with binary digital totals which are all equal to the predetermined numeral does not exist, the splicing module further combines any three of the plurality of images to acquire image combinations and calculates binary digit totals of each user of the acquired image combinations, and then combines any four of the plurality of images, and so on, until the acquired image combination with binary digital totals which are all equal to the predetermined numeral exists. When the acquired image combination with binary digital totals equal to the predetermined numeral exists, the splicing module determines the acquired image combination with binary digital totals equal to the predetermined numeral as the determined image combination.

At block 240, the splicing module determines a primary image from each of the image combination. In the embodiment, the splicing module calculates the number of users with eyes opened in each image of the image combination, and determines an image with a largest number of users who have opened eyes as the primary image of the image combination.

At block 250, the splicing module replaces closed eyes of the primary image with opened eyes of one or more other images of the image combination. In the embodiment, the splicing module can obtain eye areas of the one or more other images of the image combination with eyes opened, and replace eye areas of the primary image with eyes closed with the obtained eye areas. In other embodiment, the splicing module can obtain facial areas of the one or more other images of the image combination with eyes opened, and substitute those facial areas in the primary image where eyes are closed with the obtained facial areas. In other embodiment, the splicing module can also obtain body areas of the one or more other images of the image combination with eyes opened, and replace body areas of the primary image with eyes closed with the obtained body areas. The body areas are surface areas of the bodies of users in the plurality of images.

At block 260, the splicing module displays the primary image on a display screen of the electronic device. In the embodiment, more than one image combination may be determined for producing a resulting image showing eyes of all the users opened, and more than one replaced primary image with eyes of all the users opened is displayed on the display screen. The splicing module can obtain a preferred image selected from the more than one replaced primary image by an operator, and store the preferred image to the storage system.

At block 270, the splicing module displays the image with eyes of all the users opened on the display screen. When more than one image with eyes of all the users opened is displayed on the display screen, a preferred image can be selected from the more than one image and store to the storage system.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for splicing images of an electronic device, the method comprising:
acquiring, from a storage system of the electronic device, a plurality of images of plurality of users;
identifying, by a processor of the electronic device, eye states of the users in the plurality of images;
determining, by the processor, an image combination with eyes of all the users opened from the plurality of images based on the eyes states;
determining, by the processor, a primary image from amongst the image combination;
replacing closed eyes of the primary image with opened eyes of one or more other images of the image combination; and
displaying, on a display screen of the electronic device, the primary image.

2. The method according to claim 1, wherein the eye states are identified by:
identifying facial areas of the users from the plurality of images;
identifying eye areas of the users from the facial areas of the plurality of images;
detecting the number of visible eyeballs in each eye area of the users in the plurality of images; and
determining eye states of each user in the eye areas according to the number of visible eyeballs of each eye area.

3. The method according to claim 1, wherein the eye states are identified by:
determining that an eye state of a user in an eye area of the plurality of images is in an opened state when the number of visible eyeballs is equal to two in the eye area; and
determining that the eye state of the user in the eye area of the plurality of images is in a closed state when the number of visible eyeballs is less than two in the eye area.

4. The method according to claim 1, further comprising:
recording the eye states of the users in the plurality of images as binary digits; and
storing the recorded binary digits of the users to the storage system.

5. The method according to claim 1, wherein the image combination comprises two or more images of the plurality of images.

6. The method according to claim 1, wherein the primary image of the image combination is determined by:
calculating the number of users with eyes opened in each image of the image combination; and
determining an image with a largest number of users who have opened eyes as the primary image of the image combination.

7. The method according to claim 1, wherein the closed eyes of the primary image are replaced by at least one of:
obtaining eye areas of the one or more other images of the image combination with eyes opened, and replacing eye areas of the primary image with eyes closed with the obtained eye areas;
obtaining facial areas of the one or more other images of the image combination with eyes opened, and substituting those facial areas in the primary image where eyes are closed with the obtained facial areas; and
obtaining body areas of the one or more other images of the image combination with eyes opened, and substituting body areas of the primary image where eyes are closed with the obtained body areas.

8. An electronic device for splicing images of the electronic device, the electronic device comprising:
a display screen and at least one a processor; and
a storage system that stores one or more programs, when executed by the at least one processor, cause the at least one processor to:
acquire a plurality of images of plurality of users from the storage system;
identify eye states of the users in the plurality of images by the processor;
determine an image combination with eyes of all the users opened from the plurality of images based on the eyes states;
determine a primary image from amongst the image combination;
replace closed eyes of the primary image with opened eyes of one or more other images of the image combination; and
display the primary image on the display screen.

9. The electronic device according to claim 8, wherein the eye states are identified by:
identifying facial areas of the users from the plurality of images;
identifying eye areas of the users from the facial areas of the plurality of images;
detecting the number of visible eyeballs in each eye area of the users in the plurality of images; and
determining eye states of each user in the eye areas according to the number of visible eyeballs of each eye area.

10. The electronic device according to claim 8, wherein the eye states are identified by:
determining that an eye state of a user in an eye area of the plurality of images is in an opened state when the number of visible eyeballs is equal to two in the eye area; and
determining that the eye state of the user in the eye area of the plurality of images is in a closed state when the number of visible eyeballs is less than two in the eye area.

11. The electronic device according to claim 8, wherein the one or more programs further cause the at least one processor to:
record the eye states of the users in the plurality of images as binary digits; and
store the recorded binary digits of the users to the storage system.

12. The electronic device according to claim 8, wherein the image combination comprises two or more images of the plurality of images.

13. The electronic device according to claim 8, wherein
the primary image of the image combination is determined by:
calculating the number of users with eyes opened in each image of the image combination; and
determining an image with a largest number of users who have opened eyes as the primary image of the image combination.

14. The electronic device according to claim 8, wherein the closed eyes of the primary image are replaced by at least one of:
obtaining eye areas of the one or more other images of the image combination with eyes opened, and replacing eye areas of the primary image with eyes closed with the obtained eye areas;
obtaining facial areas of the one or more other images of the image combination with eyes opened, and substituting those facial areas in the primary image where eyes are closed with the obtained facial areas; and
obtaining body areas of the one or more other images of the image combination with eyes opened, and substituting body areas of the primary image where eyes are closed with the obtained body areas.

15. A non-transitory storage medium having stored thereon instructions that, when executed by a processor of an electronic device, causes the processor to perform a method for splicing images of the electronic device, wherein the method comprises:
acquiring, from a storage system of the electronic device, a plurality of images of plurality of users;
identifying, by the processor, eye states of the users in the plurality of images;
determining, by the processor, an image combination with eyes of all the users opened from the plurality of images based on the eyes states;
determining, by the processor, a primary image from amongst the image combination;
replacing closed eyes of the primary image with opened eyes of one or more other images of the image combination; and
displaying, on a display screen of the electronic device, the primary image.

16. The non-transitory storage medium according to claim 15, wherein the eye states are identified by:
identifying facial areas of the users from the plurality of images;
identifying eye areas of the users from the facial areas of the plurality of images;
detecting the number of visible eyeballs in each eye area of the users in the plurality of images; and
determining eye states of each user in the eye areas according to the number of visible eyeballs of each eye area.

17. The non-transitory storage medium according to claim 15, wherein the eye states are identified by:
determining that an eye state of a user in an eye area of the plurality of images is in an opened state when the number of visible eyeballs is equal to two in the eye area; and
determining that the eye state of the user in the eye area of the plurality of images is in a closed state when the number of visible eyeballs is less than two in the eye area.

18. The non-transitory storage medium according to claim 15, wherein the method further comprises:
recording the eye states of the users in the plurality of images as binary digits; and
storing the recorded binary digits of the users to the storage system.

19. The non-transitory storage medium according to claim 15, wherein the primary image of the image combination is determined by:
calculating the number of users with eyes opened in each image of the image combination; and
determining an image with a largest number of users who have opened eyes as the primary image of the image combination.

20. The non-transitory storage medium according to claim 15, wherein
closed eyes of the primary image are replaced by at least one of:
obtaining eye areas of the one or more other images of the image combination with eyes opened, and replacing eye areas of the primary image with eyes closed with the obtained eye areas;
obtaining facial areas of the one or more other images of the image combination with eyes opened, and substituting those facial areas in the primary image where eyes are closed with the obtained facial areas; and
obtaining body areas of the one or more other images of the image combination with eyes opened, and substituting body areas of the primary image where eyes are closed with the obtained body areas.
